(19) United States
(12) Patent Application Publication
(10) Pub. No.: US 2013/0286534 A1
(43) Pub. Date: Oct. 31, 2013

(54) VARIABLE-CAPACITOR DEVICE AND DRIVING METHOD THEREOF

(71) Applicant: KABUSHIKI KAISHA TOSHIBA, Tokyo (JP)

(72) Inventors: Tamio IKEHASHI, Yokohama-shi (JP); Hiroaki YAMAZAKI, Yokohama-shi (JP)

(21) Appl. No.: 13/838,939

(22) Filed: Mar. 15, 2013

(30) Foreign Application Priority Data
Apr. 27, 2012 (JP) 2012-103926

(51) Int. Cl. H01G 5/04

(52) U.S. Cl. CPC H01G 5/04
USPC 361/281

(57) ABSTRACT

According to one embodiment, a variable-capacitor device includes a first MEMS variable-capacitor element, and a second MEMS variable-capacitor element including one end series-connected to one end of the first MEMS variable-capacitor element. In a down-state, a first capacitance value of the first MEMS variable-capacitor element differs from a second capacitance value of the second MEMS variable-capacitor element.

### CROSS-REFERENCE TO RELATED APPLICATIONS

This application is based upon and claims the benefit of priority from Japanese Patent Application No. 2012-103926, filed Apr. 27, 2012, the entire contents of which are incorporated herein by reference.

### FIELD

Embodiments described herein relate generally to a variable-capacitor device including a MEMS (Micro-Electro-Mechanical Systems) variable-capacitor element, and a driving method thereof.

### BACKGROUND

A device (to be referred to as a MEMS variable-capacitor device hereinafter) in which a MEMS is applied as a variable-capacitor element can achieve a low loss, high isolation, and high linearity, and hence is expected as a key device for implementing a multi-band, multi-mode configuration of a next-generation portable terminal.

When the MEMS variable-capacitor device is applied to, e.g., a GSM® (Global System for Mobile communications) wireless system, the MEMS variable-capacitor device needs to be switched while an RF (Radio Frequency) power of about 35 dBm is applied. That is, while a high RF power is applied, the MEMS variable-capacitor device needs to return from a state (down-state) in which an upper electrode forming the MEMS variable-capacitor device is pulled down to a lower electrode, to a state (up-state) in which the upper electrode is pulled up from the lower electrode. The switching operation while RF power is applied is called hot switching.

In the hot switching operation in the MEMS variable-capacitor device, it is desired to improve the power proofness by designing the MEMS variable-capacitor device so that its capacitance value can be changed while a high RF power is applied.

### BRIEF DESCRIPTION OF THE DRAWINGS

FIG. 1 is an equivalent circuit diagram showing a MEMS variable-capacitor device according to the first embodiment;

FIG. 2A is a plan view showing the HEMS variable-capacitor device according to the first embodiment;

FIG. 2B is a sectional view showing the MEMS variable-capacitor device according to the first embodiment;

FIG. 3 is a view for explaining pull-in and pull-out of a MEMS variable-capacitor element according to the first embodiment;

FIG. 4 is a view for explaining the relationship between the capacitance value and voltage difference of the MEMS variable-capacitor element according to the first embodiment;

FIG. 5A is a plan view showing the driving state of the MEMS variable-capacitor device according to the first embodiment;

FIG. 5B is a sectional view showing the driving state of the MEMS variable-capacitor device according to the first embodiment;

FIG. 6 is a graph showing the relationship between a distance g between the upper electrode and the lower electrodes, and voltage differences ΔV1 and ΔV2 in the MEMS variable-capacitor element according to the first embodiment;

FIG. 7A is a plan view showing a MEMS variable-capacitor device according to the second embodiment;

FIG. 7B is a sectional view showing the MEMS variable-capacitor device according to the second embodiment;

FIG. 8 is a timing chart for explaining a MEMS variable-capacitor device driving method according to the second embodiment;

FIG. 9 is an equivalent circuit diagram showing a MEMS variable-capacitor device according to the third embodiment;

FIG. 10 is a schematic sectional view showing structure example 1 of the MEMS variable-capacitor device according to the third embodiment;

FIG. 11 is a schematic sectional view showing structure example 2 of the MEMS variable-capacitor device according to the third embodiment;

FIG. 12 is an equivalent circuit diagram showing a MEMS variable-capacitor device according to the fourth embodiment;

FIG. 13 is an equivalent circuit diagram showing another MEMS variable-capacitor device according to the fourth embodiment;

FIG. 14 is an equivalent circuit diagram showing a MEMS variable-capacitor device according to the fifth embodiment;

FIG. 15 is a timing chart showing bias method 1 for the MEMS variable-capacitor device according to the fifth embodiment;

FIG. 16 is a timing chart showing bias method 2 for the MEMS variable-capacitor device according to the fifth embodiment;

FIG. 17 is an equivalent circuit diagram showing a capacitance bank including a plurality of MEMS variable-capacitor devices according to the sixth embodiment;

FIG. 18A is a plan view showing a MEMS variable-capacitor device according to the seventh embodiment; and

FIG. 18B is a sectional view showing the MEMS variable-capacitor device according to the seventh embodiment.

### DETAILED DESCRIPTION

In general, according to one embodiment, a variable-capacitor device includes a first MEMS variable-capacitor element, and a second MEMS variable-capacitor element including one end series-connected to one end of the first MEMS variable-capacitor element. In a down-state, a first capacitance value of the first MEMS variable-capacitor element differs from a second capacitance value of the second MEMS variable-capacitor element.

Embodiments will now be described with reference to the accompanying drawings. In the following description, the same reference numerals denote the same parts throughout the drawings.

### [1] First Embodiment

### [1-1] Outline

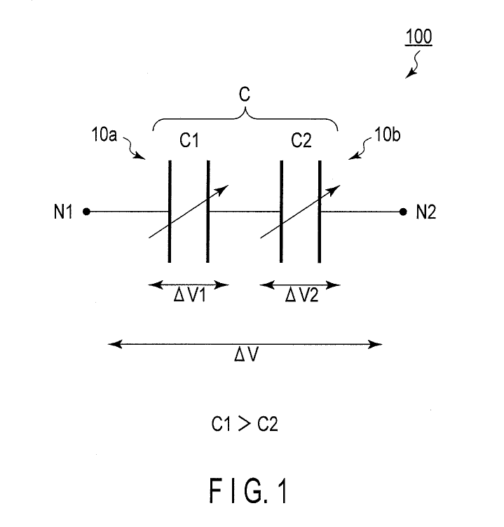

The outline of a MEMS variable-capacitor device according to the first embodiment will be described with reference to FIG. 1.

As shown in FIG. 1, a MEMS variable-capacitor device 100 according to the first embodiment includes two MEMS variable-capacitor elements 10a and 10b. The first variable-capacitor element 10a and second variable-capacitor element 10b are series-connected to each other. When the first and second variable-capacitor elements 10a and 10b are in the down-state, a capacitance value C1 of the first variable-capacitor element 10a and a capacitance value C2 of the second variable-capacitor element 10b differ from each other.

When the voltage difference between terminals N1 and N2 of the MEMS variable-capacitor device 100 is ΔV, a voltage difference applied to the first variable-capacitor element 10a is ΔV1 (CV/C1), and a voltage difference applied to the second variable-capacitor element 10b is ΔV2 (CV/C2). C is the combined capacitance value of the capacitance values C1 and C2 between the terminals N1 and N2.

In the first embodiment, the capacitance value C1 of the first variable-capacitor element 10a is set to be larger than the capacitance value C2 of the second variable-capacitor element 10b. When the voltage difference ΔV is applied between the terminals N1 and N2, the voltage difference ΔV1 applied to the first variable-capacitor element 10a becomes lower than the voltage difference ΔV2 applied to the second variable-capacitor element 10b. Thus, when driving both the first and second variable-capacitor elements 10a and 10b from the down-state to the up-state, the first variable-capacitor element 10a is pulled out prior to the second variable-capacitor element 10b.

### [1-2] Structure

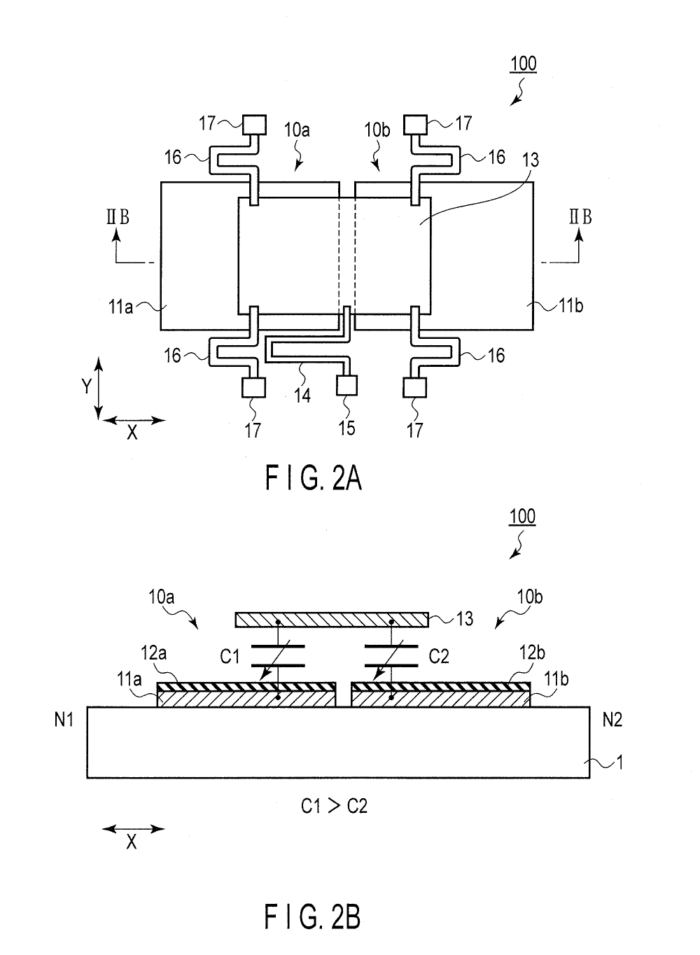

The structure of the MEMS variable-capacitor device according to the first embodiment will be explained with reference to FIGS. 2A and 2B. FIG. 2B is a sectional view taken along a line IIB-IIB in FIG. 2A.

As shown in FIGS. 2A and 2B, the MEMS variable-capacitor device 100 according to the embodiment includes the two variable-capacitor elements 10a and 10b which are series-connected on a substrate 1. The first variable-capacitor element 10a includes a lower electrode 11a and upper electrode 13. The second variable-capacitor element 10b includes a lower electrode 11b and the upper electrode 13.

When the first and second variable-capacitor elements 10a and 10b are in the down-state, the capacitance value C1 of the first variable-capacitor element 10a is set to be larger than the capacitance value C2 of the second variable-capacitor element 10b. That is, the overlapping area between the upper electrode 13 and the lower electrode 11a is larger than that between the upper electrode 13 and the lower electrode 11b. Note that the method of making the capacitance values C1 and C2 nonuniform is not limited to the method of setting different overlapping areas between the upper electrode 13 and the lower electrodes 11a and 11b. For example, the thicknesses of insulating films 12a and 12b or the dielectric constants of the first and second variable-capacitor elements 10a and 10b may be made different.

The substrate 1 is, e.g., an insulating substrate of glass or the like, or an interlayer dielectric film formed on a silicon substrate. When the substrate 1 is an interlayer dielectric film on a silicon substrate, elements such as transistors may be arranged on the surface of the silicon substrate. These elements form a logic circuit and storage circuit. The interlayer dielectric film is formed on the silicon substrate to cover these circuits. The MEMS variable-capacitor device 100 is arranged, e.g., above the circuits on the silicon substrate.

It is desirable not to arrange, below the MEMS variable-capacitor device 100, a circuit serving as a noise generation source such as an oscillator. Propagation of noise from a lower circuit to the MEMS variable-capacitor device 100 may be suppressed by arranging a shield metal in the interlayer dielectric film. The interlayer dielectric film on the silicon substrate is desirably made of a low-k material to decrease the parasitic capacitance. For example, TEOS (TetraEthylOrthoSilicate) is used as the interlayer dielectric film. Also, the interlayer dielectric film is desirably thick to decrease the parasitic capacitance.

The lower electrodes 11a and 11b are arranged on the substrate 1 to be electrically insulated from each other. The lower electrodes 11a and 11b have, e.g., a quadrangular planar shape. For example, the lower electrode 11a functions as a signal electrode, and the lower electrode 11b functions as a ground electrode.

The insulating films 12a and 12b are formed on the lower electrodes 11a and 11b, respectively. The insulating films 12a and 12b may have the same film thickness or different film thicknesses.

The upper electrode 13 is arranged above the lower electrodes 11a and 11b and faces them. The upper electrode 13 has, e.g., a quadrangular planar shape and extends in the X direction. The upper electrode 13 is movable, and moves up and down (vertical direction) with respect to the surface of the substrate 1. More specifically, the distance between the upper electrode 13 and the lower electrodes 11a and 12b changes. Along with this change, the capacitance values C1 and C2 of the variable-capacitor elements 10a and 10b change. Note that the upper electrode 13 may have an opening (through hole) which extends through the upper electrode 13 from its upper surface to its bottom surface. The planar shapes of the upper electrode 13 and lower electrodes 11a and 11b may deform into various shapes such as a circle and ellipse.

One end of a bias line 14 is connected to one side of the upper electrode 13. One terminal of the bias line 14 is arranged on the upper electrode 13. The junction between the bias line 14 and the upper electrode 13 has a stacked structure. The bias line 14 has, e.g., a meander planar shape. Note that the bias line 14 may be integrated with the upper electrode 13.

One end of each of four spring structure portions 16 is connected to a corresponding one of the four corners of the quadrangular upper electrode 13. One end of each spring structure portion 16 is arranged on the upper electrode 13. The junction between the spring structure portion 16 and the upper electrode 13 has a stacked structure. The spring structure portion 16 has, e.g., a meander planar shape.

The other end of the bias line 14 is connected to an anchor portion 15, and the other end of each spring structure portion 16 is connected to a corresponding anchor portion 17. The anchor portions 15 and 17 are arranged on the substrate 1 and formed at, e.g., the same wiring level as the upper electrode 13.

The upper electrode 13 receives a potential (voltage) via the bias line 14 and anchor portion 15. The spring structure portions 16 and anchor portions 17 support the upper electrode 13 to float. That is, an air gap (cavity) is formed between the lower electrodes 11a and 11b and the upper electrode 13.

The lower electrodes 11a and 11b and upper electrode 13 are electrically connected to a driving circuit (not shown). The driving circuit applies a driving voltage to the upper electrode 13 via the bias line 14. Note that driving voltages to the upper electrode 13 and lower electrodes 11a and 11b may be applied via resistor elements (not shown). This prevents leakage of a radio-frequency (RF) signal to the path of the bias line 14.

The lower electrodes 11a and 11b and upper electrode 13 are made of, e.g., a metal such as aluminum (Al), copper (Cu), gold (Au), or platinum (Pt), or an alloy containing one of these metals.

The bias line 14 is made of, e.g., a conductive material. The bias line 14 may use the same material as that of the upper electrode 13 or lower electrodes 11a and 11b.

The spring structure portion 16 may be made of an insulating material, semiconductor material, or conductive material. Examples of the insulating material are silicon oxide and silicon nitride. Examples of the semiconductor material are polysilicon (poly-Si), silicon (Si), and silicon germanium (Site). Examples of the conductive material are tungsten (W), molybdenum (Mo), and an aluminum-titanium (AlTi) alloy. The spring structure portion 16 may be made of a material different from that of the bias line 14.

The anchor portions 15 and 17 are made of, e.g., a conductive material. The anchor portions 15 and 17 may be made of the same material as that of one of the lower electrodes 11a and 11b, upper electrode 13, bias line 14, and spring structure portion 16, or a material different from them. The anchor portions 15 and 17 may be made of the same material or materials different from each other.

Note that the material used for the spring structure portion 16 is desirably a brittle material, and the material used for the bias line 14 is desirably a ductile material. However, a material other than the brittle material may be used for the spring structure portion 16, or the same material as that of the bias line 14 may be used for it.

The brittle material is a material, a member made of which is destroyed without causing almost no plastic deformation (shape change) when stress is applied to the member to destroy it. The ductile material is a material, a member made of which is destroyed after causing a large plastic deformation (extension) when stress is applied to the member to destroy it. Generally, energy (stress) required to destroy a member using the brittle material is lower than that required to destroy a member using the ductile material. That is, a member using the brittle material is destroyed more readily than a member using the ductile material.

By appropriately setting, e.g., the line width, film thickness, and flexure of the spring structure portion 16, a spring constant k2 of the spring structure portion 16 using the brittle material is made larger than a spring constant k1 of the bias line 14 using the ductile material.

When the bias line 14 made of the ductile material and the spring structure portion 16 made of the brittle material are connected to the upper electrode 13 as in the embodiment, the spacing between the upper electrode 13 and the lower electrodes 11a and 11b in a state (up-state) in which the upper electrode 13 is pulled up is practically determined by the spring constant k2 of the spring structure portion 16 using the brittle material.

The spring structure portion 16 using the brittle material hardly causes a creep phenomenon, as described above. Even when the MEMS variable-capacitor device 100 is repetitively driven a plurality of times, therefore, the spacing between the upper electrode 13 and the lower electrodes 11a and 11b in the up-state hardly fluctuates. Note that the creep phenomenon is a phenomenon in which the aged deterioration increases or a phenomenon in which the distortion (shape change) of a given member increases when stress is applied to the member.

The bias line 14 using the ductile material sometimes causes the creep phenomenon when driven a plurality of times. However, the spring constant k1 of the bias line 14 is set to be smaller than the spring constant k2 of the spring structure portion 16 using the brittle material. Accordingly, the shape change (deflection) of the bias line 14 using the ductile material exerts no large influence on the spacing between the upper electrode 13 and the lower electrodes 11a and 11b in the up-state.

In this manner, the spring structure (bias line 14) using the ductile material and the spring structure (spring structure portion 16) using the brittle material are applied to the MEMS variable-capacitor device 100. There can therefore be provided the MEMS variable-capacitor device 100 in which characteristic deterioration by the creep phenomenon is small while maintaining the advantage of a low loss.

In the MEMS variable-capacitor device 100 according to the embodiment, the drivable upper electrode 13 forms an electrostatic actuator. In the MEMS variable-capacitor device 100, electrostatic attraction occurs by giving a voltage difference between the upper electrode 13 and the lower electrodes 11a and 11b. The electrostatic attraction generated between the upper electrode 13 and the lower electrodes 11a and 11b moves the upper electrode 13 in a direction (vertical direction) perpendicular to the surface of the substrate 1, thereby fluctuating the distance between the upper electrode 13 and the lower electrodes 11a and 11b which form the capacitor elements 10a and 10b. The fluctuations in distance change the capacitance values (electrostatic capacitance values) C1 and C2 of the MEMS variable-capacitor device 100.

In the MEMS variable-capacitor device 100 of the embodiment, the variable-capacitor elements 10a and 10b having variable electrostatic capacitances (capacitive coupling) are series-connected between the lower electrodes 11a and 11b (terminals N1 and N2). The series-connected electrostatic capacitances (combined capacitance) C1 and C2 provide the variable capacitance of the MEMS variable-capacitor device 100.

### [1-3] Principle

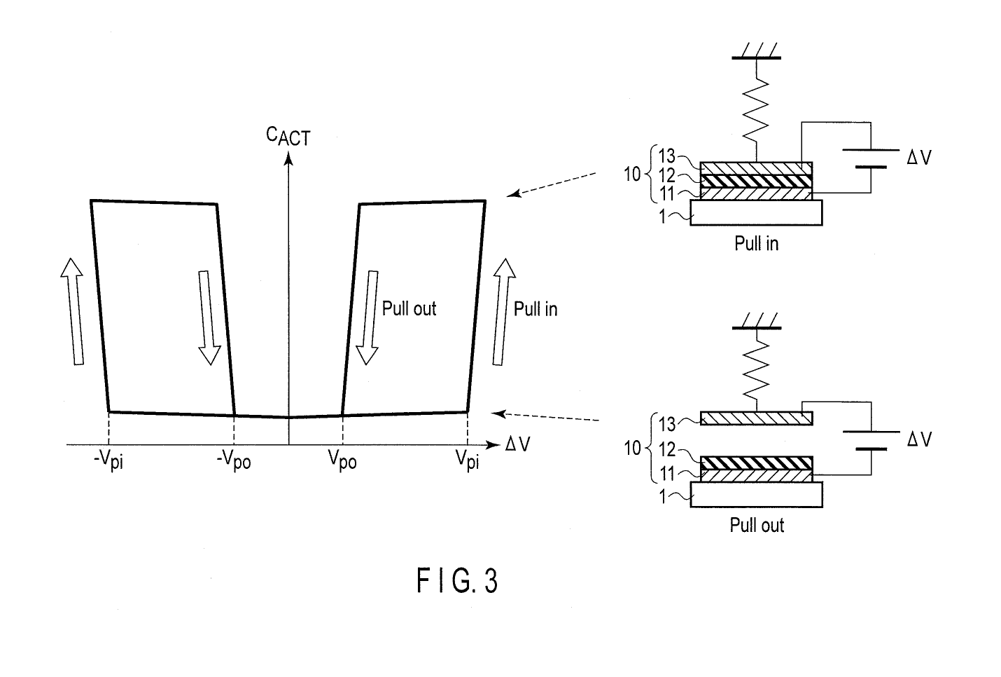

The driving principle of the MEMS variable-capacitor device (the operation of the electrostatic actuator) according to the first embodiment will be explained with reference to FIG. 3.

As shown in FIG. 3, when the voltage difference ΔV between the lower electrode 11 and the upper electrode 13 becomes equal to or higher than a pull-in voltage Vₚᵢ, the upper electrode 13 comes down to the lower electrode 11 and is pulled in. In contrast, when the voltage difference ΔV between the lower electrode 11 and the upper electrode 13 becomes equal to or lower than a pull-out voltage Vₚₒ, the upper electrode 13 moves apart from the lower electrode 11 and is pulled out.

A hot switching operation when the MEMS variable-capacitor device 100 shifts from the down-state to the up-state will be explained. Assuming that RF power of an effective voltage V_{eff} is applied to the MEMS variable-capacitor device 100, electrostatic attraction arising from the voltage V_{eff} acts in the down-state. If the spring structure portion 16 supporting the upper electrode 13 is weak (the spring constant is small), it cannot resist the electrostatic attraction and the upper electrode 13 cannot shift to the up-state (cannot be pulled out) even upon stopping the driving voltage. More specifically, when V_{eff}>Vₚₒ, the upper electrode 13 cannot be pulled out. In other words, by strengthening the spring structure portion 16 (increasing the spring constant), the pull-out voltage Vₚₒ rises and the upper electrode 13 can be easily pulled out. However, a shift to the down-state requires a high driving voltage, resulting in a long switching time and large current consumption.

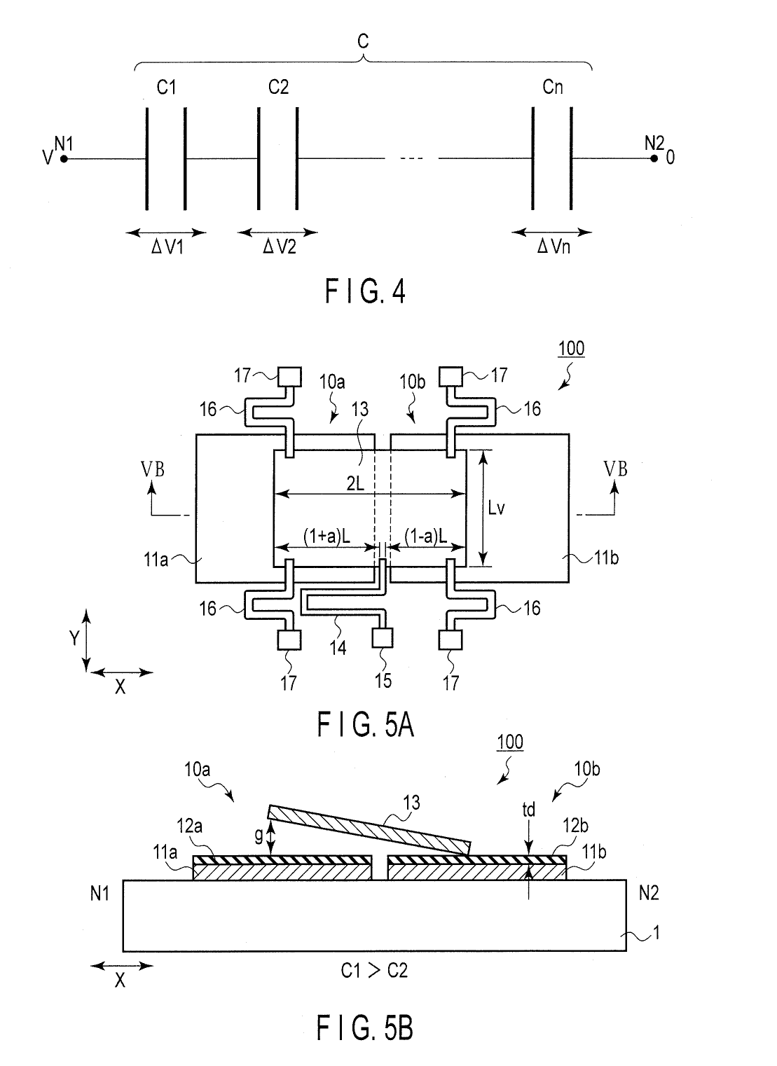

A voltage difference ΔVi applied to each capacitive element when n capacitive elements are series-connected and the voltage difference V is applied between the terminals N1 and N2 will be explained with reference to FIG. 4. The total capacitance value C of the n capacitive elements is given by equation (1):

$$\frac{1}{C} = \frac{1}{C 1} + \frac{1}{C 2} + ⋯ + \frac{1}{Cn} \qquad equation ( 1 )$$

As represented by equation (2), as the capacitance value Ci of each capacitive element is larger, the voltage difference ΔVi applied to each capacitive element becomes lower:

$$Δ Vi = \frac{CV}{Ci} \qquad equation ( 2 )$$

In the first embodiment, the capacitance value C1 of the first variable-capacitor element 10a is larger than the capacitance value C2 of the second variable-capacitor element 10b. When the voltage difference V is applied between the terminals N1 and N2, the voltage difference ΔV1 applied to the first variable-capacitor element 10a becomes lower than the voltage difference ΔV2 applied to the second variable-capacitor element 10b. When C1>C2, ΔV1<ΔV2, and the first variable-capacitor element 10a is pulled out prior to the second variable-capacitor element 10b.

### [1-4] Operation

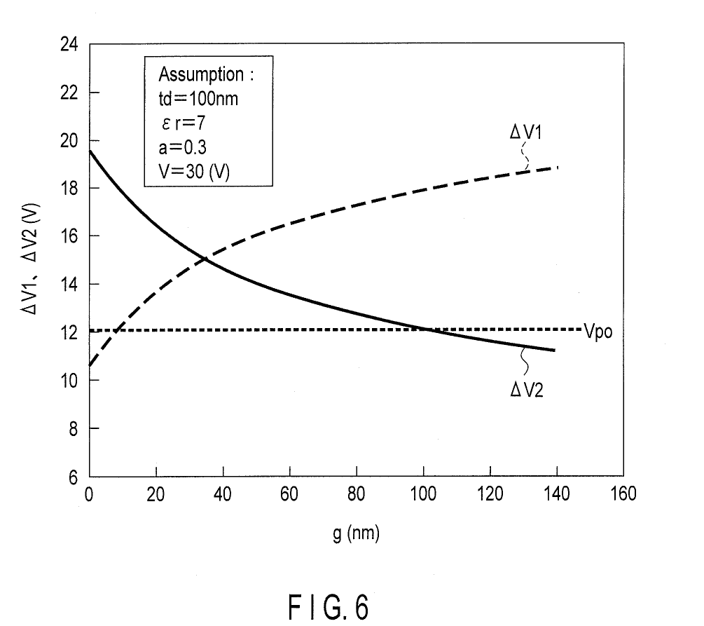

The operation of the MEMS variable-capacitor device according to the first embodiment will be described with reference to FIGS. 5A, 5B, and 6. FIG. 5B is a sectional view taken along a line VB-VB in FIG. 5A.

In the first embodiment, when the first and second variable-capacitor elements 10a and 10b satisfy a relation of C1>C2, ΔV1<ΔV2 holds, as described above. Hence, the first variable-capacitor element 10a is pulled out prior to the second variable-capacitor element 10b.

More specifically, as shown in FIG. 5B, an end of the upper electrode 13 on the side of the first variable-capacitor element 10a floats and moves apart from the lower electrode 11a (insulating film 12a) by a distance g. At this time, an end of the upper electrode 13 on the side of the second variable-capacitor element 10b remains in contact with the lower electrode 11b (insulating film 12b).

The dimensions of the upper electrode 13 will be defined below, as shown in FIG. 5A. When the X width of the upper electrode 13 is 2 L and a parameter a is used, a width by which the upper electrode 13 and lower electrode 11a overlap each other is (1+a)L, and a width by which the upper electrode 13 and lower electrode 11b overlap each other is (1−a)L. In this case, the capacitance values C1 and C2 are calculated as functions of g according to equations (3) and (4):

$$\begin{matrix}C 1 ( g ) = C 0 \times log [ \frac{2 Z + 2}{( 1 - a ) Z + 2} ] & equation ( 3 ) \\ C 2 ( g ) = C 0 \times log [ \frac{( 1 - a ) Z + 2}{2} ] \\ C 0 = {ɛ}_{0} \frac{2 {LL}_{y}}{g} \\ Z = g \text{/} ( t \text{/} {ɛ}_{0} ) & equation ( 4 )\end{matrix}$$

FIG. 6 shows a graph pertaining to the voltage differences ΔV1 and ΔV2 applied to the variable-capacitor elements 10a and 10b based on equations (3) and (4). In FIG. 6, assume that the thickness td of the insulating films 12a and 12b on the lower electrodes 11a and 11b is 100 nm, the relative dielectric constant ∈r is 7, a is 0.3, the voltage difference V between N1 and N2 is 30 V, and the pull-out voltage Vₚₒ is 12 V.

As is apparent from FIG. 6, if the voltage V=30 V is applied between N1 and N2 when there is no spacing between an end of the upper electrode 13 on the side of the first variable-capacitor element 10a and the lower electrode 11a (g=0), the voltage difference ΔV1=10.5 V is applied to the first variable-capacitor element 10a and the voltage difference ΔV2=19.5 V is applied to the second variable-capacitor element 10b. Since the voltage difference ΔV1 (10.5 V) is lower than the pull-out voltage Vₚₒ (12 V), an end of the upper electrode 13 on the side of the first variable-capacitor element 10a floats and is pulled out. Subsequent, when g becomes equal to or larger than 100 nm, the voltage difference ΔV2 applied to the second variable-capacitor element 10b becomes lower than the pull-out voltage Vₚₒ (12 V), and an end of the upper electrode 13 on the side of the second variable-capacitor element 10b is also pulled out. As a result, the entire upper electrode 13 changes to the up-state.

When an end of the upper electrode 13 on the side of the first variable-capacitor element 10a floats by g=140 nm, ΔV1 increases as the capacitance value C1 decreases. However, ΔV1 at this time is much lower than the pull-in voltage Vₚᵢ, so an end of the upper electrode 13 on the side of the first variable-capacitor element 10a does not come down again (that is, is not pulled in).

### [1-5] Effects

According to the first embodiment, the two variable-capacitor elements 10a and 10b are series-connected to each other, and the capacitance value C1 of the first variable-capacitor element 10a in the down-state is set to be larger than the capacitance value C2 of the second variable-capacitor element 10b. When the MEMS variable-capacitor device 100 is driven from the down-state to the up-state, the voltage ΔV1 applied to the first variable-capacitor element 10a having the large capacitance value C1 becomes lower than the voltage ΔV2 applied to the second variable-capacitor element 10b having the small capacitance value C2. Accordingly, the first variable-capacitor element 10a is pulled out prior to the second variable-capacitor element 10b. In this manner, according to the embodiment, the two variable-capacitor elements 10a and 10b are pulled out not simultaneously but sequentially by setting a time difference. For this reason, while a high RF power is applied, the capacitance value of the MEMS variable-capacitor device 100 can be changed, that is, hot switching becomes possible, improving the power proofness and breakdown voltage of the MEMS variable-capacitor device 100.

For example, when the parameter a (a>0) described with reference to FIGS. 5A, 5B, and 6 is used, the embodiment can increase the breakdown voltage by (1+a) times, compared to a case in which the capacitance values C1 and C2 are uniform (a=0).

Although the combined capacitance C (=C1C2/(C1+C2)) of the capacitance values C1 and C2 is multiplied by (1−a2) times and decreases, the rate of decrease of the combined capacitance C is lower than the rate of improvement of the breakdown voltage. As a whole, the embodiment is advantageous. For example, when a=0.1, the breakdown voltage improves by 10%, and the capacitance value decreases only by 1%.

### [2] Second Embodiment

In the second embodiment, upper electrodes 13a and 13b of two variable-capacitor elements 10a and 10b can be moved independently. A difference of the second embodiment from the first embodiment will be mainly described.

### [2-1] Structure

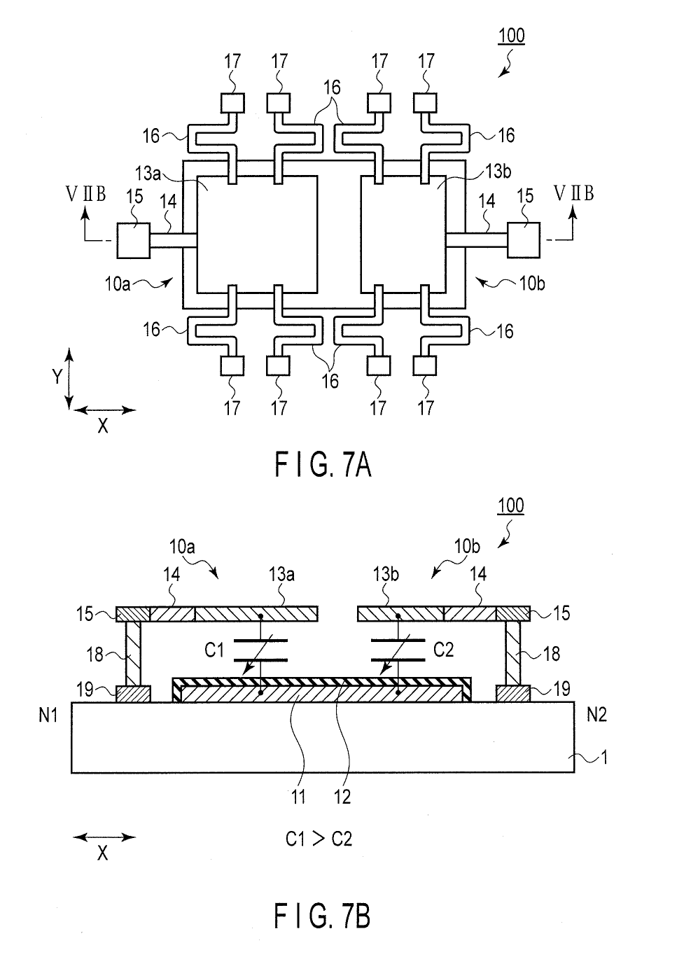

The structure of a MEMS variable-capacitor device according to the second embodiment will be explained with reference to FIGS. 7A and 7B. FIG. 7B is a sectional view taken along a line VIIB-VIIB in FIG. 7A.

As shown in FIGS. 7A and 7B, the second embodiment is different from the first embodiment in that the upper electrodes 13a and 13b of the two variable-capacitor elements 10a and 10b can be moved independently. In the first embodiment, the two variable-capacitor elements 10a and 10b share the movable upper electrode 13. In the second embodiment, the movable upper electrodes 13a and 13b are electrically insulated from each other and are separately arranged in the two variable-capacitor elements 10a and 10b. Also, in the first embodiment, the lower electrodes 11a and 11b are separately arranged in the two variable-capacitor elements 10a and 10b. In the second embodiment, the two variable-capacitor elements 10a and 10b share a lower electrode 11.

In the second embodiment, for example, the area of the upper electrode 13a is made larger than that of the upper electrode 13b in order to set the capacitance value C1 of the first variable-capacitor element 10a to be larger than the capacitance value C2 of the second variable-capacitor element 10b.

Each of the upper electrodes 13a and 13b is connected to a plurality of spring structure portions 16 and a bias line 14. Each spring structure portion 16 is connected to a corresponding anchor portion 17. The bias line 14 is connected to an anchor portion 15. The anchor portion 15 is connected to a wiring line 19 via a contact 18. The wiring line 19 is formed on a substrate 1 and arranged at, e.g., the same level as the lower electrode 11.

### [2-2] Operation

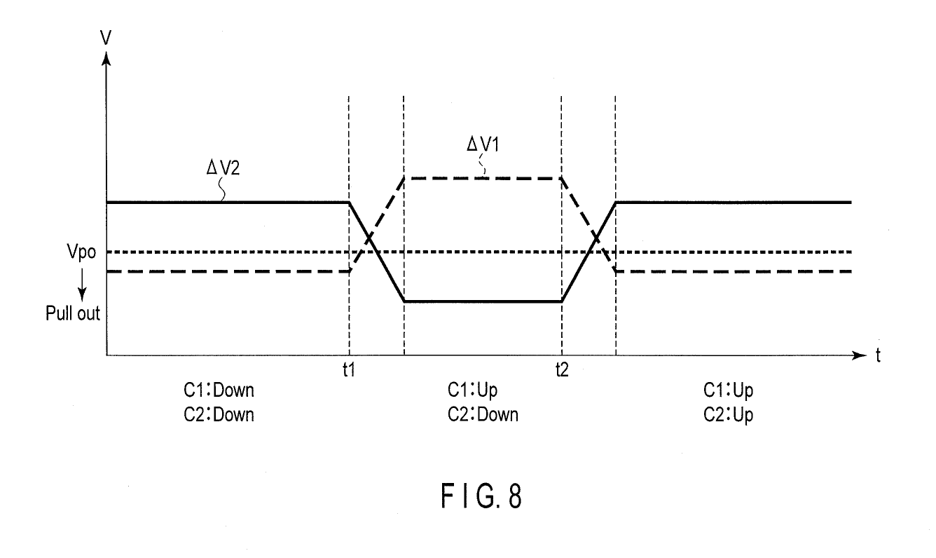

A case in which both the first and second variable-capacitor elements 10a and 10b shift from the down-state to the up-state will be explained with reference to FIG. 8. Here, ΔV1 is a voltage difference applied to the first variable-capacitor element 10a, and ΔV2 is a voltage difference applied to the second variable-capacitor element 10b.

As shown in FIG. 8, first, the first variable-capacitor element 10a having the low voltage difference ΔV1 is pulled out at timing t1. When the first variable-capacitor element 10a changes to the up-state, the capacitance value C1 decreases and becomes smaller than the capacitance value C2 of the second variable-capacitor element 10b in the down-state. At this time, ΔV2 becomes low, and the second variable-capacitor element 10b is pulled out at timing t2.

In this fashion, the first and second variable-capacitor elements 10a and 10b (upper electrodes 13a and 13b) are moved independently, and a variable-capacitor element having a larger capacitance value is pulled out first.

### [2-3] Effects

The second embodiment can obtain the same effects as those of the first embodiment.

In the second embodiment, the first and second variable-capacitor elements 10a and 10b can be independently moved by arranging the upper electrodes 13a and 13b to be electrically isolated from each other.

### [3] Third Embodiment

The first and second embodiments have described a case in which there are two variable-capacitor elements 10a and 10b. To the contrary, the third embodiment will explain a case in which there are three or more variable-capacitor elements. A difference of the third embodiment from the first and second embodiments will be mainly described.

### [3-1] Structure

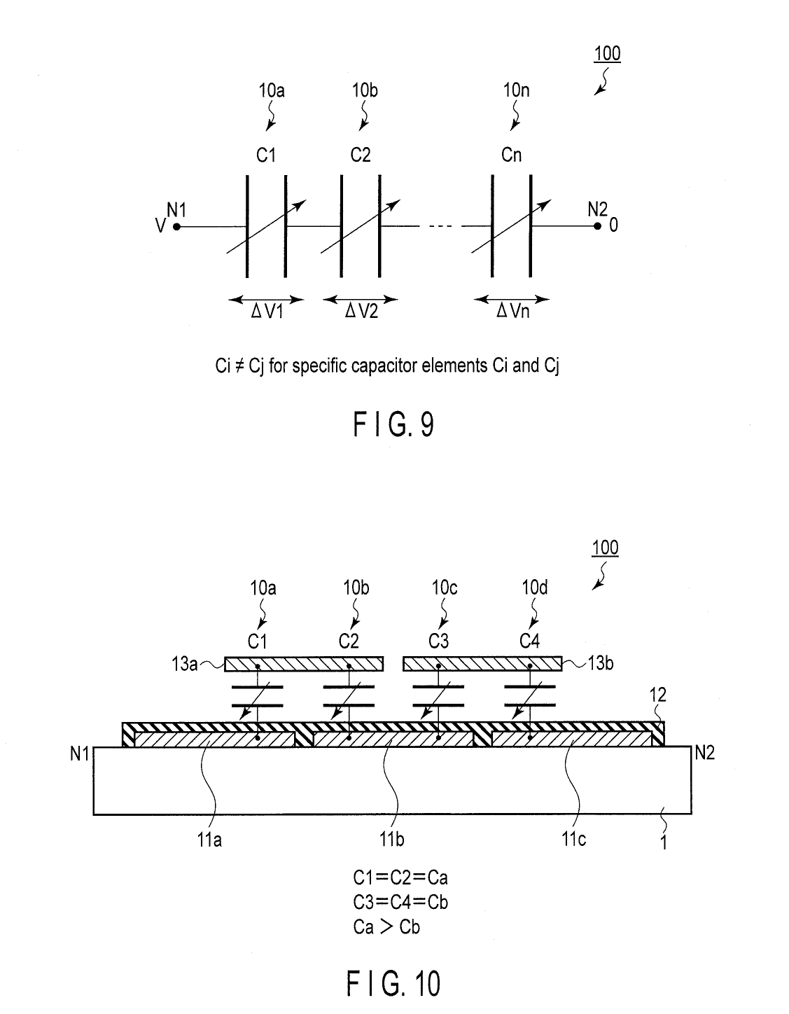

The schematic structure of a MEMS variable-capacitor device according to the third embodiment will be explained with reference to FIG. 9.

As shown in FIG. 9, n variable-capacitor elements 10a, 10b, . . . , 10n are series-connected in a MEMS variable-capacitor device 100 according to the third embodiment.

In the third embodiment, when pulling out the n variable-capacitor elements 10a, 10b, . . . , 10n, a variable-capacitor element having a largest capacitance value among the capacitance values C1, C2, . . . , Cn of the n variable-capacitor elements 10a, 10b, . . . , 10n is pulled out first.

The capacitance values of only some of the n variable-capacitor elements suffice to be nonuniform. For example, when C1= . . . =C3=Ca, C4=Cb, C5= . . . C8=Ca, C9=Cc, and C10= . . . =C15=Ca, it suffices to satisfy a relation of Cb>Cc. In this case, the variable-capacitor element 10d having the capacitance value C4 is pulled out first.

Note that a variable-capacitor element having a largest capacitance value may be arranged at an arbitrary position such as an end or the center between terminals N1 and N2. When a radio-frequency signal is input from the terminal N1, variable-capacitor elements may be arranged so that a variable-capacitor element closer to the terminal N1 has a larger capacitance value, and a variable-capacitor element closest to the terminal N1 may be pulled out first. In addition, the total number of variable-capacitor elements to be series-connected may be an odd or even number.

### [3-2] Structure Example 1

Structure example 1 of the MEMS variable-capacitor device according to the third embodiment will be explained with reference to FIG. 10.

As shown in FIG. 10, the MEMS variable-capacitor device 100 in structure example 1 includes four variable-capacitor elements 10a, 10b, 10c, and 10d.

The first variable-capacitor element 10a is formed from a lower electrode 11a and upper electrode 13a, and has the capacitance value C1. The second variable-capacitor element 10b is formed from a lower electrode 11b and the upper electrode 13a, and has the capacitance value C2. The third variable-capacitor element 10c is formed from the lower electrode 11b and an upper electrode 13b, and has the capacitance value C3. The fourth variable-capacitor element 10d is formed from a lower electrode 11c and the upper electrode 13b, and has the capacitance value C4. That is, the first and second variable-capacitor elements 10a and 10b share the upper electrode 13a, the third and fourth variable-capacitor elements 10c and 10d share the upper electrode 13b, and the second and third variable-capacitor elements 10b and 10c share the lower electrode 11b. The four variable-capacitor elements 10a, 10b, 10c, and 10d are series-connected.

The capacitance values C1, C2, C3, and C4 of the four variable-capacitor elements 10a, 10b, 10c, and 10d in the down-state may be set to be C1=C2=Ca, and C3=C4=Cb, where Ca>Cb. In this case, the first and second variable-capacitor elements 10a and 10b are pulled out prior to the third and fourth variable-capacitor elements 10c and 10d.

### [3-3] Structure Example 2

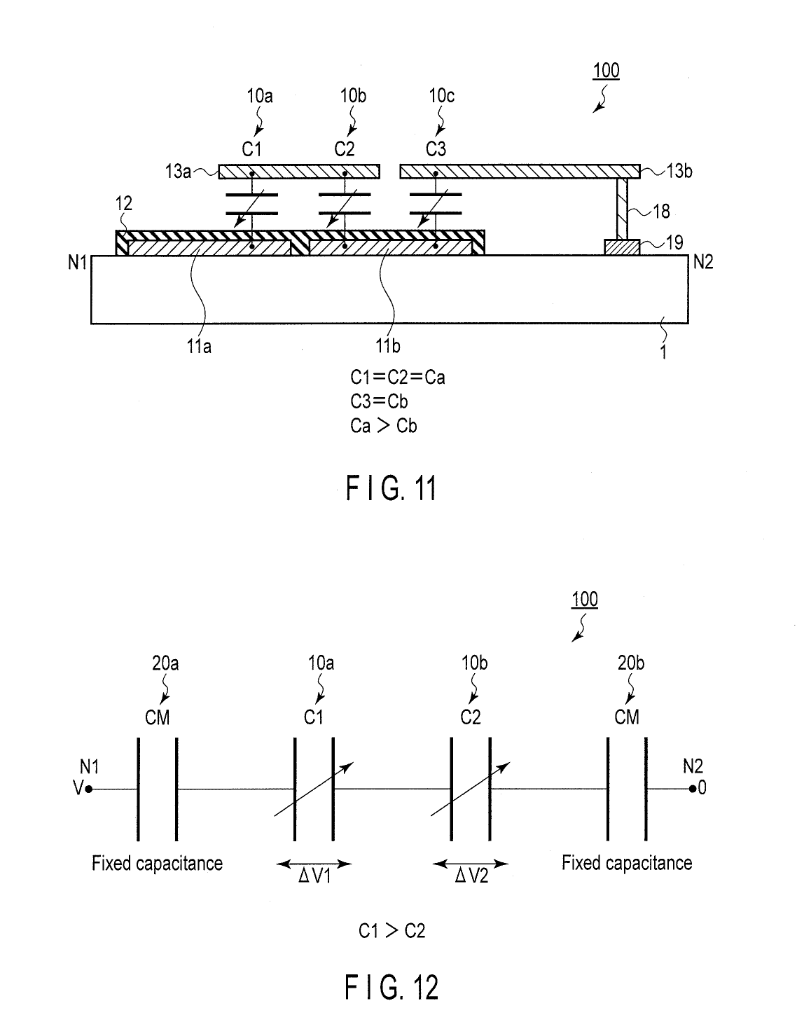

Structure example 2 of the MEMS variable-capacitor device according to the third embodiment will be explained with reference to FIG. 11.

As shown in FIG. 11, the MEMS variable-capacitor device 100 in structure example 2 includes three variable-capacitor elements 10a, 10b, and 10c.

The first variable-capacitor element 10a is formed from the lower electrode 11a and upper electrode 13a, and has the capacitance value C1. The second variable-capacitor element 10b is formed from the lower electrode 11b and upper electrode 13a, and has the capacitance value C2. The third variable-capacitor element 10c is formed from the lower electrode 11b and upper electrode 13b, and has the capacitance value C3. That is, the first and second variable-capacitor elements 10a and 10b share the upper electrode 13a, and the second and third variable-capacitor elements 10b and 10c share the lower electrode 11b. The three variable-capacitor elements 10a, 10b, and 10c are series-connected. The upper electrode 13b is connected to the wiring line 19 on the substrate 1 via the contact 18.

The capacitance values C1, C2, and C3 of the three variable-capacitor elements 10a, 10b, and 10c in the down-state may be set to be C1=C2=Ca, and C3=Cb, where Ca>Cb. In this case, the first and second variable-capacitor elements 10a and 10b are pulled out prior to the third variable-capacitor element 10c.

### [3-4] Effects

The third embodiment can obtain the same effects as those of the first and second embodiments even when the MEMS variable-capacitor device 100 includes three or more variable-capacitor elements.

In the third embodiment, by increasing the number of variable-capacitor elements, a voltage applied to each variable-capacitor element can be decreased when the MEMS variable-capacitor device 100 is driven, thereby further improving the power proofness.

### [4] Fourth Embodiment

In the fourth embodiment, fixed-capacitor elements are further added to the two ends of series-connected variable-capacitor elements. A difference of the fourth embodiment from the first to third embodiments will be mainly described.

### [4-1] Structure

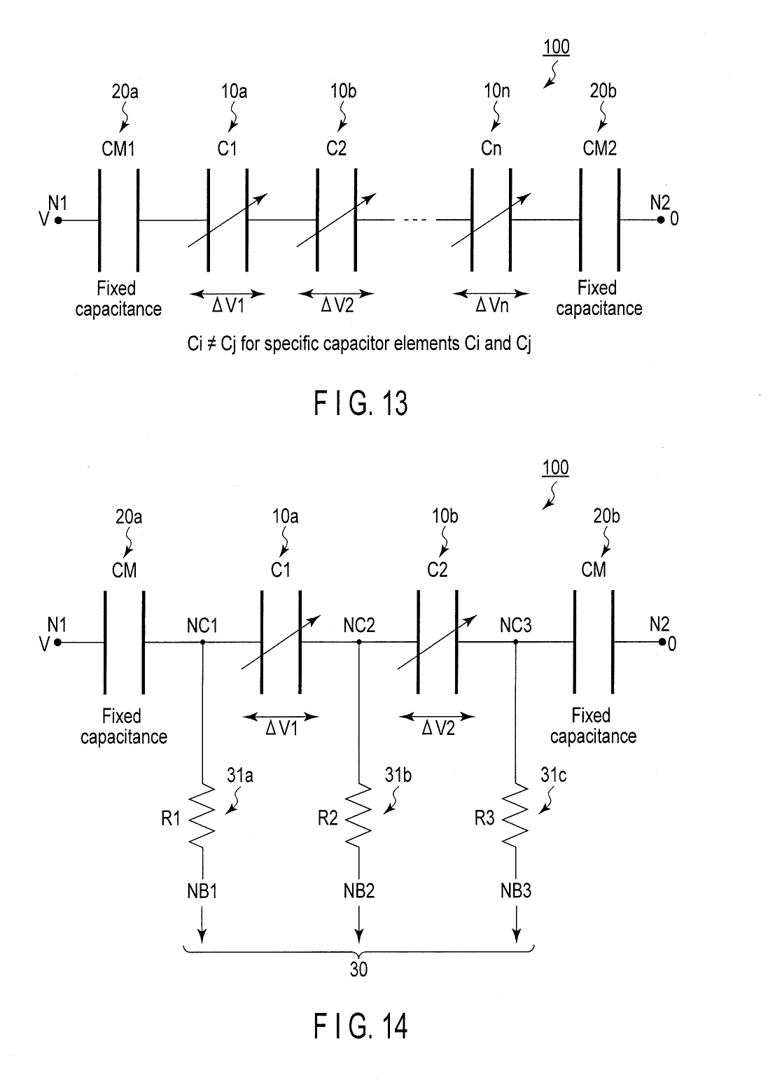

The structure of a MEMS variable-capacitor device according to the fourth embodiment will be explained with reference to FIGS. 12 and 13.

As shown in FIGS. 12 and 13, in the fourth embodiment, fixed-capacitor elements 20a and 20b are arranged at the two ends of series-connected variable-capacitor elements. Two variable-capacitor elements 10a and 10b may be interposed between the fixed-capacitor elements 20a and 20b (FIG. 12), or three or more variable-capacitor elements 10a, 10b, 10n may be interposed (FIG. 13).

The capacitance value CM of the fixed-capacitor elements 20a and 20b may be equal to the capacitance value of an arbitrary variable-capacitor element or may be different. The fixed-capacitor elements 20a and 20b are not limited to be arranged at the two ends of series-connected variable-capacitor elements, and may be arranged at only one end.

### [4-2] Effects

The fourth embodiment can obtain the same effects as those of the first to third embodiments.

In the fourth embodiments, the fixed-capacitor elements 20a and 20b are arranged at the two ends of series-connected variable-capacitor elements. When the MEMS variable-capacitor device 100 is driven, voltages applied to respective capacitor elements (variable-capacitor elements and fixed-capacitor elements) can be decreased, thereby further improving the power proofness. Further, the fixed-capacitor elements 20a and 20b can suppress leakage of an RF signal to the outside.

### [5] Fifth Embodiment

The fifth embodiment will describe a bias circuit for implementing driving of, e.g., a MEMS variable-capacitor device 100 in FIG. 12. Note that the bias circuit in the fifth embodiment is not limitedly applied to the MEMS variable-capacitor device 100 in FIG. 12, but is applicable to, e.g., a MEMS variable-capacitor device configured to independently drive the upper electrode. A difference of the fifth embodiment from the first to fourth embodiments will be mainly described.

### [5-1] Structure

The structure of a MEMS variable-capacitor device according to the fifth embodiment will be explained with reference to FIG. 14.

As shown in FIG. 14, a MEMS variable-capacitor device 100 according to the fifth embodiment includes a bias circuit 30. The bias circuit 30 supplies a voltage to one end of each of resistor elements 31a, 31b, and 31c (terminals NB1, NB2, and NB3) having resistance values R1, R2, and R3. The two ends of the resistor element 31a are connected to a terminal NC1 and the terminal NB1, respectively. The two ends of the resistor element 31b are connected to a terminal NC2 and the terminal NB2, respectively. The two ends of the resistor element 31c are connected to a terminal NC3 and the terminal NB3, respectively. The terminal NC1 is connected to one electrode of a first variable-capacitor element 10a and one electrode of a first fixed-capacitor element 20a. The terminal NC2 is connected to the other electrode of the first variable-capacitor element 10a and one electrode of a second variable-capacitor element 10b. The terminal NC3 is connected to the other electrode of the second variable-capacitor element 10b and one electrode of a second fixed-capacitor element 20b. The terminals NB1, NB2, and NB3 are connected to the bias circuit 30.

Note that the fixed-capacitor elements 20a and 20b are desirably arranged at two ends between terminals N1 and N2. This can prevent leakage of an RF signal.

### [5-2] Bias Method 1

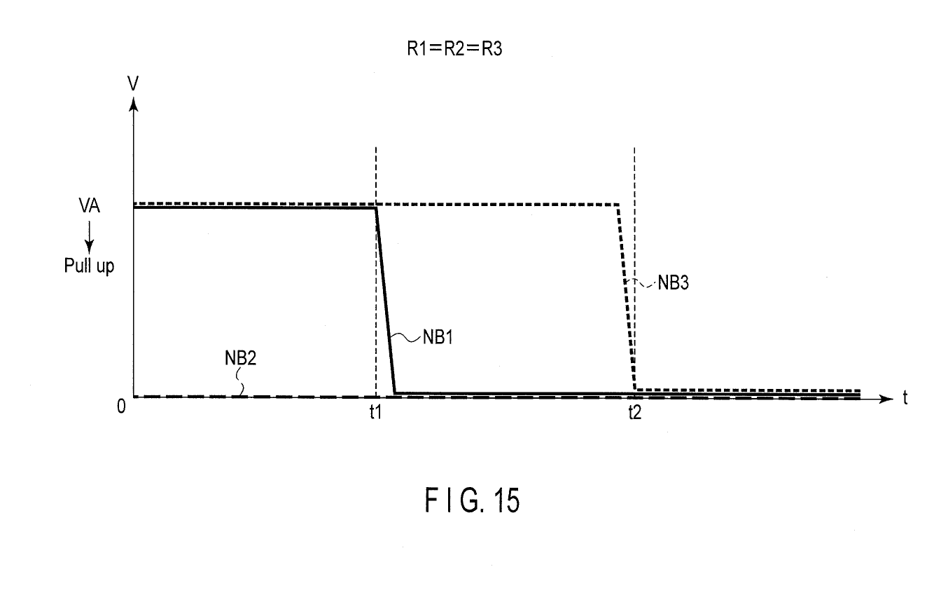

Bias method 1 for the MEMS variable-capacitor device according to the fifth embodiment will be explained with reference to FIG. 15. In bias method 1, all the resistance values F1, R2, and R3 of the resistor elements 31a, 31b, and 31c are equal (R1=R2=R3). VA is a driving voltage for maintaining the down-state. When a voltage becomes lower than VA, pull-up occurs.

As shown in FIG. 15, the voltage VA is applied to the terminals NB1 and NB3 from timing t=0 to timing t1. Then, the application voltage to the terminal NB1 is set to be 0 while the application voltage to the terminal NB3 remains VA from timing t1 to timing t2. After that, at timing t2, the application voltage to the terminal NB3 is set to be 0. In this bias operation, the application voltage to the terminal NB2 is always 0.

In bias method 1, the application voltage to the terminal NB1 is set to be 0 at timing t1, and the application voltage to the terminal NB3 is set to be 0 at timing t2. That is, voltage differences are given to the first and second variable-capacitor elements 10a and 10b at different timings. Hence, the first variable-capacitor element 10a changes to the up-state first at timing t1, and then the second variable-capacitor element 10b changes to the up-state at timing t2.

In bias method 1, the resistance value R2 of the resistor element 31b need not always be equal to the resistance values R1 and R3 of the resistor elements 31a and 31c, and may be higher or lower than the resistance values R1 and R3.

### [5-3] Bias Method 2

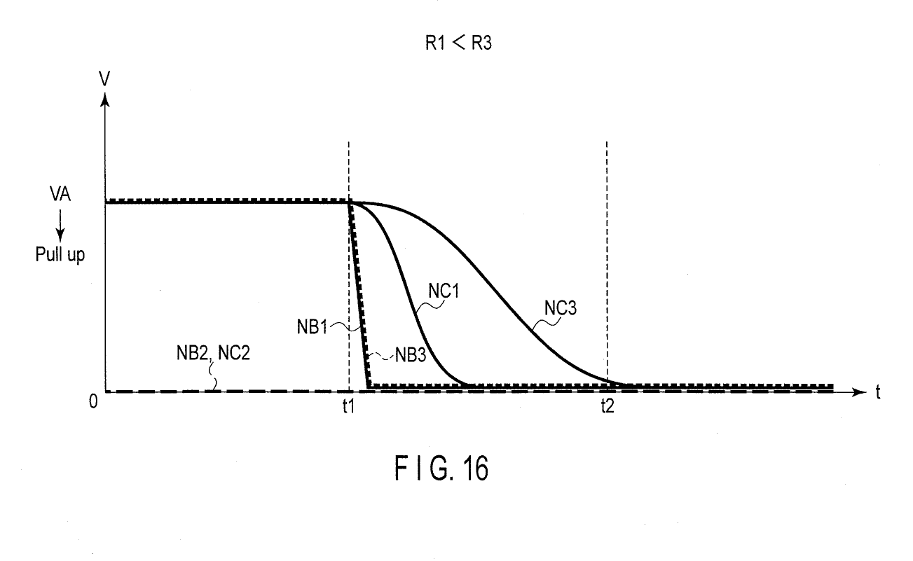

Bias method 2 for the MEMS variable-capacitor device according to the fifth embodiment will be explained with reference to FIG. 16. In bias method 2, the resistance value R1 of the resistor element 31a is lower than the resistance value R3 of the resistor element 31c (R1<R3). Note that the resistance value R2 of the r resistor element 31b may be equal to or different from either one of the resistance values R1 and R3 of the resistor elements 31a and 31c.

As shown in FIG. 16, the voltage VA is applied to the terminals NB1 and NB3 from timing t=0 to timing t1. Then, at timing t1, both the application voltages to the terminals NB1 and NB3 are set to be 0. Since the resistance value R1 is lower than the resistance value R3, the potential of the terminal NC1 drops prior to that of the terminal NC3. Hence, the potential of the terminal NC1 becomes 0 between timing t1 and timing t2, and that of the terminal NC3 becomes 0 around timing t2.

In bias method 2, both the application voltages to the terminals NB1 and NB3 are set to be 0 at timing t1, and voltage differences are given to the first and second variable-capacitor elements 10a and 10h at the same timing. However, the resistance values E1 and R3 of the resistor elements 31a and 31c are different from each other. Since a relation of R1<R3 holds, even if voltage differences are simultaneously given to the terminals NB1 and NB3, bias method 2 generates a wiring delay and thus generates a time difference between the voltage displacements of the terminals NC1 and NC3 in the MEMS variable-capacitor device 100. For this reason, the first variable-capacitor element 10a changes to the up-state first between timing t1 and timing t2, and then the second variable-capacitor element 10b changes to the up-state at timing t2.

### [5-4] Effects

In the fifth embodiment, the bias circuit 30 is connected to the variable-capacitor elements 10a, 10b, and 10c via the resistor elements 31a, 31b, and 31c. By using the bias circuit 30, voltage differences are given to the first and second variable-capacitor elements 10a and 10b at different timings. This can make different the pull-up timings of the first and second variable-capacitor elements 10a and 10b. The fifth embodiment can obtain the same effects as those of the first to fourth embodiments.

The fifth embodiment can suppress leakage of an RF signal to the terminals NB1, NB2, and NB3 by arranging the resistor elements 31a, 31b, and 31c.

### [6] Sixth Embodiment

The sixth embodiment will exemplify a capacitance bank including a plurality of MEMS variable-capacitor devices. A difference of the sixth embodiment from the first to fifth embodiments will be mainly described.

### [6-1] Structure

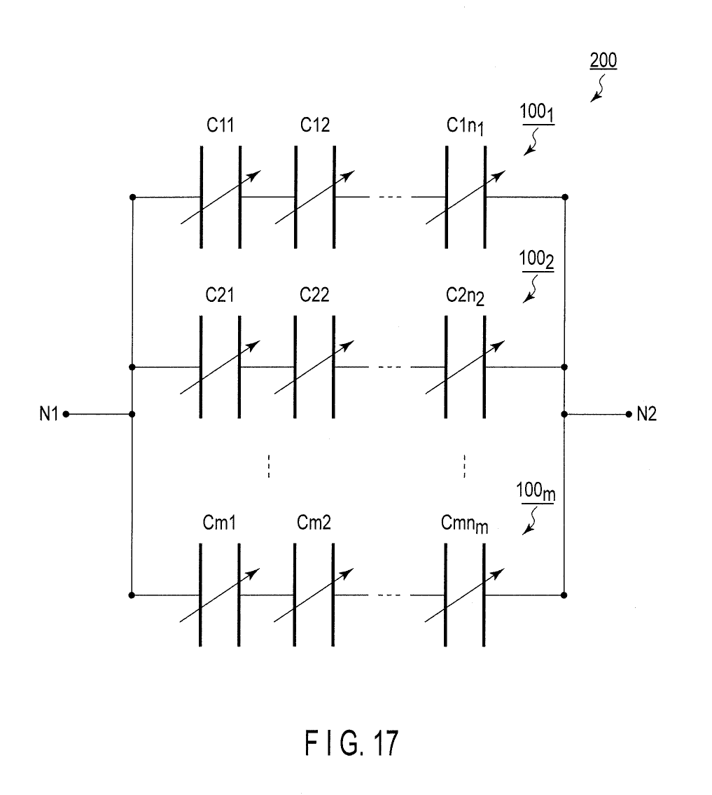

The structure of the capacitance bank according to the sixth embodiment will be described with reference to FIG. 17.

As shown in FIG. 17, in the sixth embodiment, a capacitance bank 200 is constituted using a plurality of MEMS variable-capacitor devices 100₁, 100₂, . . . , 100ₘ. Each of the MEMS variable-capacitor devices 100₁, 100₂, . . . , 100ₘ is formed from one of the MEMS variable-capacitor devices 100 described in the first to fifth embodiments. The MEMS variable-capacitor devices 100₁, 100₂, . . . , 100ₘ may have the same arrangement or different arrangements. The MEMS variable-capacitor devices 100₁, 100₂, . . . , 100ₘ may include the same number or different numbers of variable-capacitor elements n1, n2, . . . , nm to be series-connected.

The MEMS variable-capacitor devices 100₁, 100₂, . . . , 100ₘ can be controlled to take two states, i.e., up-state and down-state independently.

### [6-2] Effects

The sixth embodiment can obtain the same effects as those of the first to fifth embodiments.

### [7] Seventh Embodiment

The seventh embodiment further adopts a driving electrode for driving the upper electrode of a variable-capacitor element. A difference of the seventh embodiment from the first embodiment will be mainly described.

### [7-1] Structure

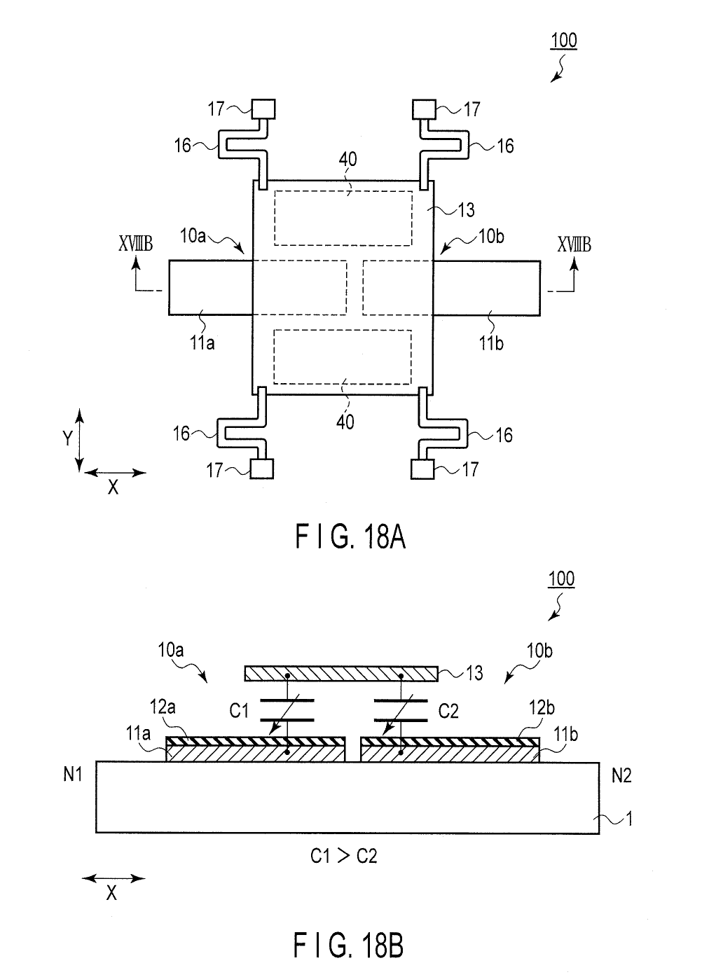

The structure of a MEMS variable-capacitor device according to the seventh embodiment will be explained with reference to FIGS. 18A and 18B. FIG. 18B is a sectional view taken along a line XVIIIB-XVIIIB in FIG. 18A.

As shown in FIGS. 18A and 18B, the seventh embodiment is different from the first embodiment in that driving electrodes 40 for driving an upper electrode 13 are further arranged. In the first embodiment, the upper electrode 13 and driving electrode are integrated. In contrast, in the seventh embodiment, the upper electrode 13 and driving electrodes 40 are formed separately.

The driving electrodes 40 are formed on a substrate 1 and arranged at the same level as lower electrodes 11a and 11b.

### [7-2] Effects

The seventh embodiment can obtain the same effects as those of the first embodiment.

In the seventh embodiment, the driving electrodes 40 are arranged separately from the upper electrode 13. Since the driving electrodes 40 can be separated from the RF electrodes (upper electrode 13 and lower electrodes 11a and 11b), a low-pass filter can be omitted.

The seventh embodiment is also applicable to the MEMS variable-capacitor devices according to the second to sixth embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A variable-capacitor device comprising:
a first MEMS variable-capacitor element; and
a second MEMS variable-capacitor element including one end series-connected to one end of the first MEMS variable-capacitor element,
wherein in a down-state, a first capacitance value of the first MEMS variable-capacitor element differs from a second capacitance value of the second MEMS variable-capacitor element.

2. The device according to claim 1, further comprising:
a first fixed-capacitor element configured to be series-connected to the other end of the first MEMS variable-capacitor element;
a second fixed-capacitor element configured to be series-connected to the other end of the second MEMS variable-capacitor element;
a first resistor element including one end connected to the other end of the first MEMS variable-capacitor element;
a second resistor element including one end connected to the one end of the first MEMS variable-capacitor element and the one end of the second MEMS variable-capacitor element;
a third resistor element including one end connected to the other end of the second MEMS variable-capacitor element; and
a bias circuit configured to supply voltages to the other end of the first resistor element, the other end of the second resistor element, and the other end of the third resistor element.

3. The device according to claim 1, wherein if a radio-frequency signal is input from the other end of the first MEMS variable-capacitor element, the first capacitance value is larger than the second capacitance value.

4. The device according to claim 1, wherein a first upper electrode forming the first MEMS variable-capacitor element and a second upper electrode forming the second MEMS variable-capacitor element are electrically isolated from each other and driven independently of each other.

5. The device according to claim 1, further comprising:
a first fixed-capacitor element configured to be series-connected to the other end of the first MEMS variable-capacitor element; and
a second fixed-capacitor element configured to be series-connected to the other end of the second MEMS variable-capacitor element.

6. The device according to claim 1, further comprising a driving electrode configured to drive an upper electrode which is shared by the first MEMS variable-capacitor element and the second MEMS variable-capacitor element.

7. A method of driving a variable-capacitor device, the variable-capacitor device including
a first MEMS variable-capacitor element, and
a second MEMS variable-capacitor element configured to be series-connected to the first. MEMS variable-capacitor element, the method comprising:
pulling out the first MEMS variable-capacitor element prior to the second MEMS variable-capacitor element when both the first MEMS variable-capacitor element and the second MEMS variable-capacitor element are driven from a down-state to an up-state.

8. The method according to claim 7, wherein the variable-capacitor device further includes
a first fixed-capacitor element configured to be series-connected to the other end of the first MEMS variable-capacitor element,
a second fixed-capacitor element configured to be series-connected to the other end of the second MEMS variable-capacitor element,
a first resistor element including one end connected to the other end of the first MEMS variable-capacitor element,
a second resistor element including one end connected to one end of the first MEMS variable-capacitor element and one end of the second MEMS variable-capacitor element,
a third resistor element including one end connected to the other end of the second MEMS variable-capacitor element, and
a bias circuit configured to supply voltages to the other end of the first resistor element, the other end of the second resistor element, and the other end of the third resistor element.

9. The method according to claim 8, wherein voltage differences are given to the first variable-capacitor element and the second variable-capacitor element at different timings.

10. The method according to claim 9, wherein the bias circuit applies the voltage to the other end of the first resistor element and the other end of the third resistor element from an initial state to a first timing,
stops application of the voltage to the other end of the first resistor element while keeping applying the voltage to the other end of the third resistor element from the first timing to a second timing,
stops application of the voltage to the other end of the third resistor element at the second timing, and
does not apply the voltage to the other end of the second resistor element during a period from the initial state to the second timing.

11. The method according to claim 8, wherein
voltage differences are given to the first variable-capacitor element and the second variable-capacitor element at the same timing, and
a resistance value of the first resistor element is lower than a resistance value of the third resistor element.

12. The method according to claim 11, wherein the bias circuit applies the voltage to the other end of the first resistor element and the other end of the third resistor element from an initial state to a first timing,
stops application of the voltage to the other end of the first resistor element and the other end of the third resistor element at the first timing, and
does not apply the voltage to the other end of the second resistor element during a period from the initial state to the first timing.

13. The method according to claim 7, wherein a first capacitance value of the first MEMS variable-capacitor element is larger than a second capacitance value of the second MEMS variable-capacitor element.

14. The method according to claim 13, wherein a radio-frequency signal is input from the other end of the first MEMS variable-capacitor element.

15. The method according to claim 7, wherein a first upper electrode forming the first MEMS variable-capacitor element and a second upper electrode forming the second MEMS variable-capacitor element are electrically isolated from each other and driven independently of each other.
